(19) United States
(12) Patent Application Publication
(10) Pub. No.: US 2026/0371247 A1
(43) Pub. Date: Nov. 19, 2026

(54) METHOD AND APPARATUS FOR MONITORING SYSTEM INFORMATION, AND READABLE STORAGE MEDIUM

(71) Applicant: Beijing Xiaomi Mobile Software Co., Ltd., Beijing (CN)

(72) Inventor: Ting FU, Beijing (CN)

(21) Appl. No.: 19/133,954

(22) PCT Filed: Dec. 19, 2022
(86) PCT No.: PCT/CN2022/140067

§ 371 Date: May 29, 2025

(51) Int. Cl. H04W 52/02; H04W 48/14

(52) U.S. Cl. CPC H04W 52/0235; H04W 48/14

(57) ABSTRACT

A method for monitoring system information is performed by a user equipment, and includes: in response to a first condition being met, monitoring first system information transmitted by a network device, wherein the first system information includes low power wake up signal (LP WUS) configuration information.

### CROSS REFERENCE TO RELATED APPLICATIONS

This application is a US National Phase of International Application No. PCT/CN2022/140067, filed on Dec. 19, 2022, the content of which is incorporated herein by reference in its entirety.

### TECHNICAL FIELD

The present disclosure relates to the field of communication technologies, in particular to a method and apparatus for monitoring system information, and a readable storage medium.

### BACKGROUND

A low power wake up signal (LP WUS) is introduced in Release 18 (R18) of a 3rd generation partnership project (3GPP). The base station transmits the LP WUS to a user equipment (UE) to wake up the UE. The UE can use a separate low-power receiver to monitor and receive the LP WUS, and wake up the main receiver to transmit and receive data after receiving the LP WUS, thus achieving energy saving of the UE. The configuration information of the LP WUS can serve as system information, and it is necessary to know the occasion when the UE obtains the system information.

### SUMMARY

According to a first aspect of the embodiments of the present disclosure, there is provided a method for monitoring system information, performed by a user equipment, including: in response to a first condition being met, monitoring first system information transmitted by a network device, where the first system information includes low power wake up signal (LP WUS) configuration information.

In the method of the present disclosure, the user equipment monitors the first system information carrying the LP WUS configuration information transmitted by the network device when a certain condition is met, and obtains the first system information in time so as to accurately monitor the LP WUS according to the valid LP WUS configuration information in the energy-saving state, such that the energy-saving effect is to ensured.

In some embodiments, monitoring the first system information transmitted by the network device includes: monitoring the first system information broadcast by the network device.

In some embodiments, monitoring the first system information transmitted by the network device includes: transmitting a system information (SI) request to the network device, where the SI request is configured to request the first system information including the LP WUS configuration information; and monitoring the first system information transmitted by the network device.

In some embodiments, the first condition includes that: an upper layer of the user equipment has a request to monitor a LP WUS.

In some embodiments, the first condition includes that: a channel quality measurement result of the user equipment is greater than or equal to a parameter threshold value.

In some embodiments, the channel quality measurement result is a measurement result corresponding to a reference signal of a serving cell.

In some embodiments, the reference signal is a synchronization signal and physical broadcast channel (PBCH) block (SSB).

In some embodiments, the parameter threshold value is defined by a protocol or configured by the network device.

In some embodiments, the parameter threshold value is related to at least one of: a difference between a transmit power of the reference signal and a transmit power of the LP WUS; or a sensitivity of a receiver for receiving the LP WUS.

According to a second aspect of the embodiments of the present disclosure, there is provided a user equipment including a processor and a memory, where the memory is configured to store computer programs executable by the processor, and the processor is configured to perform the method in the first aspect.

According to a third aspect of the present disclosure, there is provided a non-transitory computer-readable storage medium, storing instructions (or computer programs, or programs) thereon, where the instructions, when executed by a processor, cause the processor to perform the method in the first aspect.

It is to be understood that the above general descriptions and the below detailed descriptions are merely exemplary and explanatory, and are not intended to limit the present disclosure.

### BRIEF DESCRIPTION OF THE DRAWINGS

The drawings described here are used to provide a further understanding of the present specification and constitute a part of the present disclosure. The schematic implementations of the present disclosure and the description thereof are used to explain the present disclosure, and do not constitute an improper limitation on the present disclosure.

FIG. 1 is a schematic diagram illustrating a wireless communication system architecture according to an embodiment of the present disclosure.

FIG. 2 is a flowchart illustrating a method for transmitting and receiving system information according to an embodiment of the present disclosure.

FIG. 3 is a flowchart illustrating a method for transmitting and receiving system information according to another embodiment of the present disclosure.

FIG. 4 is a flowchart illustrating a method for transmitting and receiving system information according to another embodiment of the present disclosure.

FIG. 5 is a flowchart illustrating a method for monitoring system information according to an embodiment of the present disclosure.

FIG. 6 is a flowchart illustrating a method for monitoring system information according to another embodiment of the present disclosure.

FIG. 7 is a block diagram illustrating an apparatus for monitoring system information according to an embodiment of the present disclosure.

FIG. 8 is a block diagram illustrating a user equipment according to an embodiment of the present disclosure.

FIG. 9 is a block diagram illustrating an apparatus for transmitting system information according to an embodiment of the present disclosure.

FIG. 10 is a block diagram illustrating a communication device according to an embodiment of the present disclosure.

### DETAILED DESCRIPTION OF THE EMBODIMENTS

Examples will be described in detail herein, with the illustrations thereof represented in the drawings. Where the following description relates to the drawings, unless otherwise indicated, the same numerals in different drawings represent the same or similar elements. The embodiments described in the following exemplary embodiments do not represent all embodiments consistent with the present disclosure. Rather, they are merely examples of apparatuses and methods consistent with some aspects of the present disclosure as detailed in the appended claims.

The terms used in the present disclosure are for the purpose of describing a particular example only, and are not intended to limit the present disclosure. The singular forms such as “a,” “said,” and “the” used in the present disclosure and the appended claims are also intended to include multiple, unless the context clearly indicates otherwise. It will also be understood that as used herein, the term “and/or” is and includes any or all combinations of one or more of the associated listed items.

It is to be understood that although different information may be described using the terms such as “first,” “second,” “third,” etc. in the present disclosure, the information should not be limited to these terms. These terms are used only to distinguish the same type of information from each other. For example, the first information may also be referred to as the second information without departing from the scope of the present disclosure, and similarly, the second information may also be referred to as the first information. Depending on the context, as used herein, the wording “if” may be interpreted as “while . . . ” or “when . . . ” or “in response to a determination”.

Hereinafter, the embodiments of the present disclosure will be described in detail, examples of which are illustrated in the accompanying drawings, where the same or similar reference numerals indicate the same or similar elements throughout. The embodiments described below by reference to the accompanying drawings are exemplary and are intended to explain the present disclosure and are not to be construed as limiting the present disclosure.

As shown in FIG. 1, an embodiment of the present disclosure provides a method for transmitting and receiving system information that can be applied to a wireless communication system 100, which may include, but is not limited to, a user equipment 101 and a network device 102. The user equipment 101 is configured to support carrier aggregation, and the user equipment 101 may be connected to a plurality of carrier units of the network device 102, including a primary component carrier unit and one or more secondary component carrier units.

It will be understood that the wireless communication system 100 may be suitable for both low frequency and high frequency scenes. The application scenes of the wireless communication system 100 include, but are not limited to, a long term evolution (LTE) system, an LTE frequency division duplex (FDD) system, an LTE time division duplex (TDD) system, a worldwide interoperability for micro wave access (WiMAX) communication system, a cloud radio access network (CRAN) systems, a future 5th-generation (5G) system, a new radio (NR) communication system, a future evolved public land mobile network (PLMN) system, and other systems.

The user equipment 101 may be a terminal, an access terminal, a terminal unit, a terminal station, a mobile station (MS), a remote station, a remote terminal, a mobile terminal, a wireless communication device, a terminal agent, a terminal equipment, etc. The user equipment 101 may have a wireless receiving and transmitting function, which is capable of communicating (e.g., wireless communication) with one or more network devices of one or more communication systems and accepting network services provided by the network devices, which herein include, but are not limited to, a network device 102 illustrated.

The user equipment 101 may be a cellular telephone, a cordless telephone, a session initiation protocol (SIP) telephone, a wireless local loop (WLL) station, a personal digital assistant (PDA) device, a handheld device with wireless communication capabilities, a computing device, other processing devices connected to wireless modems, an on-board device, a wearable device, a terminal equipment in a future 5G network or in a future evolved PLMN network, and so on.

The network device 102 may be an access network device (or access network station). The access network device is a device that has the function of providing network access, such as a radio access network (RAN) base station and the like. The network device may include a base station (BS), or include a BS and a wireless resource management device for controlling the BS, and the like. The network device 102 may also include relay stations (relay devices), access points, and base stations in the future 5G network, and base stations or NR base stations in the future evolved PLMN network, and the like. The network device 102 may be a wearable device or an on-board device. The network device 102 can also be a communication chip with a communication module.

For example, the network device 102 includes, but is not limited to, a next-generation base station (gnodeB, gNB) in 5G, an evolved node B (eNB) in an LTE system, a radio network controller (RNC), a node B (NB) in a wideband code division multiple access (WCDMA) system, a wireless controller in a centralized radio access network (CRAN) system, a base station controllers (BSC), a base transceiver station (BTS) in a global system for mobile communication (GSM) or code division multiple access (CDMA) system, and a home base stations (e. g, home evolved node B, or home node B (HNB)), a baseband unit (BBU), a transmitting and receiving point (TRP), a transmitting point (TP), or a mobile switching center.

In related protocols, system information (SI) is divided into various types, such as paging configuration related system information, radio resource management (RRM) measurement related system information, positioning related system information, security alarm related system information and so on.

From the mechanism of updating the system information by the user equipment 101, the system information may include the following two types.

The first category of system information requires the UE to update, thus ensuring that the UE always keeps the valid version of the system information.

For example, a UE in a radio resource control idle (RRC_Idle) state and in an RRC_Inactive state shall ensure having a valid version of (at least) the master information block (MIB), system information block 1 (SIB1) through SIB4, SIB5 (if the UE supports evolved universal terrestrial radio access (E-UTRA)), SIB11 (if the UE is configured for idle/inactive measurements), SIB12 (if the UE is capable of new radio (NR) sidelink communication/discovery and is configured by upper layers to receive or transmit NR sidelink communication/discovery), and SIB13, SIB14 (if the UE is capable of V2X sidelink communication and is configured by upper layers to receive or transmit V2X sidelink communication), SIB15 (if the UE is configured by upper layers to report disaster roaming related information), SIB16 (if the UE receives network slice selection and aggregation (NSAG) information for cell reselection from upper layer), SIB19 (if the UE is accessing NR via non terrestrial network (NTN) access).

For the second category of system information, the UE does not need to keep the valid version of the SI all the time, and only needs to obtain the latest system information when necessary.

For example, positioning SIB (posSIB), SIB6, SIB7 and SIB8, etc. The UE will obtain SIB6, SIB7 or SIB8 only when the short messages indication field of paging DCI indicates that there is security alarm information. When the upper layer of the UE requests to obtain the SIB related to location, the UE will obtain the posSIB.

In addition, the LP WUS configuration information may also be transmitted to the user equipment 101 as system information.

The user equipment 101 may obtain the LP WUS configuration information only when necessary. For example, for the UE in RRC_Idle state, it is not necessary to monitor the LP WUS, so it is not necessary to always keep the valid version of the system information related to the LP WUS configuration information, and the LP WUS configuration information will been obtained only when necessary. Based on this, it is necessary to be informed about the timing of the UE obtaining the system information related to the LP WUS configuration information, or to be informed about when the UE has a need to obtain the system information related to the LP WUS configuration information.

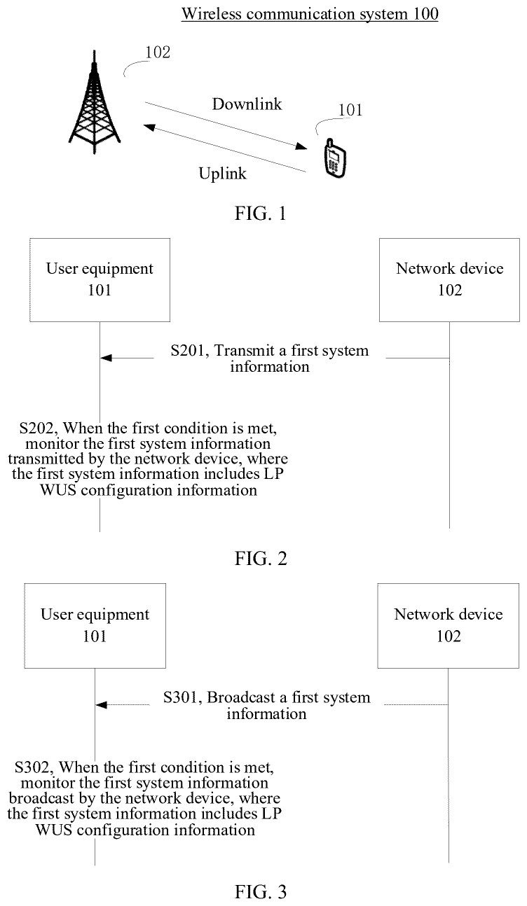

An embodiment of the present disclosure provides a method for transmitting and receiving system information. FIG. 2 is a flowchart illustrating a method for transmitting and receiving system information according to the embodiment of the present disclosure. As shown in FIG. 2, the method includes the following steps S201 to S202.

At step S201, the network device 102 transmits a first system information.

At step S202, when the first condition is met, the first system information transmitted by a network device is monitored, where the first system information includes LP WUS configuration information.

In some embodiments, the user equipment 101 decides whether to monitor the first system information carrying the LP WUS configuration information according to whether the first condition is met.

In some embodiments, the LP WUS configuration information includes one or more of: a time domain resource, a frequency domain resource, power information, spatial information and the like for transmitting the LP WUS. The spatial information can be configured to indicate transmitting and receiving beam information.

In some embodiments, the first condition is related to the request from the upper layer of the user equipment 101.

In an example, the first condition includes that: the physical layer of the user equipment 101 receives the request of the upper layer to monitor the LP WUS, that is, the upper layer of the user equipment 101 has the request to monitor the LPWUS.

The upper layer can be an application layer, and the application layer may transmit a request to monitor the LP WUS to the physical layer for energy saving. In this example, the physical layer, after receiving a request from the upper layer to monitor the LP WUS, needs to monitor the first system information carrying the LP WUS configuration information before monitoring the LP WUS to obtain valid LP WUS configuration information.

In another example, the first condition includes that: the upper layer of the user equipment 101 determines that the channel quality measurement result is greater than or equal to the corresponding threshold value.

The upper layer may be a radio resource control (RRC) layer. In this example, when the channel quality measurement result is better, the monitoring quality of the LP WUS is considered to be better as well, and the user equipment 101 can switch to the state of monitoring the LP WUS to achieve energy saving. Before switching to the state of monitoring the LP WUS, the user equipment 101 needs to monitor the first system information carrying the LP WUS configuration information to obtain the valid LP WUS configuration information.

In some embodiments, the user equipment 101 is a user equipment in the RRC idle state.

In some embodiments, after obtaining the first system information carrying the LP WUS configuration information, the user equipment 101 may switch to an energy-saving state of monitoring the LP WUS, and monitor the LP WUS through a low-power receiver at a corresponding time-frequency location in accordance with the time-frequency resource configured in the LP WUS configuration information. In the state of monitoring the LP WUS, the main receiver may be in a sleep state to achieve energy saving of the user equipment 101.

In some embodiments, the network device 102 does not use a modification period (modification period) to broadcast updated first system information related to the LP WUS configuration information when the first system information related to the LP WUS configuration information is changed.

In an example, in addition to the first system information related to the LP WUS configuration information, the system information for the earthquake and tsunami warning system (ETWS), the system information for the commercial mobile alert system (CMAS), the system information for positioning assistance data, and the system information for non terrestrial network (NTN) specific information, the updated system information can be broadcast in the modification period following the period in which the system information change indication is transmitted.

In some embodiments, when there is a change in the first system information related to the LP WUS configuration information, the system information update indication in the paging DCI will not be used to indicate the change in the LP WUS configuration information.

In an example, when the first system information related to the LP WUS configuration information changes, the system information update indication bit (such as a short messages indication field) in the paging DCI remains at a first bit value, and the first bit value is used to indicate that the system information is not changed. For example, the first bit value is 0.

In the embodiments of the present disclosure, the user equipment 101 monitors the first system information, carrying the LP WUS configuration information, transmitted by the network device 102 when a certain condition is met, and obtains the first system information in time so as to accurately monitor the LP WUS according to the valid LP WUS configuration information in the energy-saving state, such that the energy-saving effect is to ensured.

An embodiment of the present disclosure provides a method for transmitting and receiving system information. FIG. 3 is a flowchart illustrating a method for transmitting and receiving system information according to the embodiment of the present disclosure. As shown in FIG. 3, the method includes the following steps S301 to S302.

At step S301, the network device 102 broadcasts the first system information, and the first system information includes LP WUS configuration information.

At step S302, when the first condition is met, the first system information broadcast by network device 102 is monitored.

In some embodiments, the network device 102 may broadcast the first system information carrying the LP WUS configuration information according to a preset period.

In some embodiments, the first condition includes that: the upper layer of the user equipment 101 has a request to monitor the LP WUS. For example, the physical layer of the user equipment 101 receives a request from the upper layer to monitor the LP WUS.

In some embodiments, the first condition includes that: the channel quality measurement result of the user equipment 101 is greater than or equal to the corresponding parameter threshold value.

In some embodiments, the user equipment 101 is a user equipment in the RRC idle state.

In some embodiments, after obtaining the first system information carrying the LP WUS configuration information, the user equipment 101 may switch to a state of monitoring the LP WUS, and monitor the LP WUS through a low-power receiver at a corresponding time-frequency location in accordance with the time-frequency resource configured in the LP WUS configuration information. In the state of monitoring the LP WUS, the main receiver may be in a sleep state to achieve energy saving of the user equipment 101.

In the embodiments of the present disclosure, the user equipment 101 does not need to transmit system information (SI) request information, the network device 102 actively broadcasts the first system information, and the user equipment 101 monitors the first system information when the first condition is met.

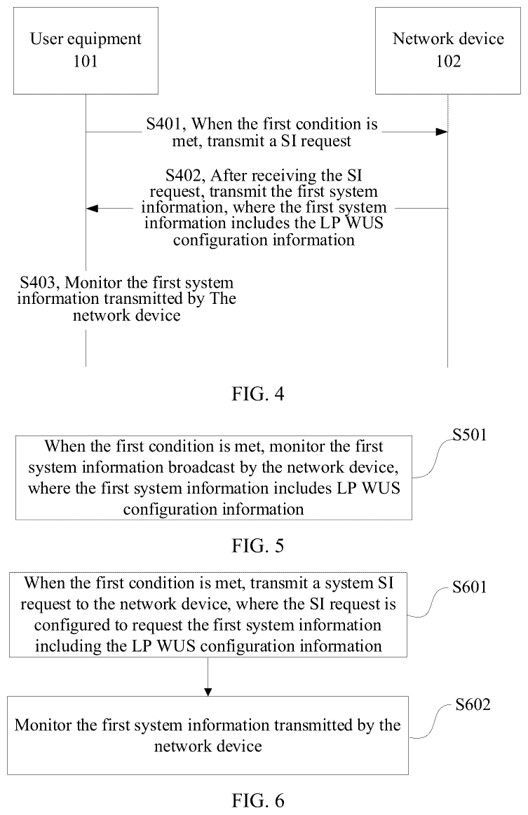

An embodiment of the present disclosure provides a method for transmitting and receiving system information. FIG. 4 is a flowchart illustrating a method for transmitting and receiving system information according to the embodiment of the present disclosure. As shown in FIG. 4, the method includes the following steps S401 to S403.

At step S401, when the first condition is met, the user equipment 101 transmits a system information (SI) request to the network device 102, where the SI request is configured to request the first system information including the LP WUS configuration information.

At step S402, after receiving the SI request, the network device 102 transmits the first system information to the user equipment 101.

At step S403, the user equipment 101 monitors the first system information transmitted by the network device 102, where the first system information includes the LP WUS configuration information.

In some embodiments, the first condition includes that: the upper layer of the user equipment 101 has a request to monitor the LP WUS. For example, the physical layer of the user equipment 101 receives a request from the upper layer to monitor the LP WUS.

In some embodiments, the first condition includes that: the channel quality measurement result of the user equipment 101 is greater than or equal to the corresponding parameter threshold value.

In some embodiments, the user equipment 101 is a user equipment in the RRC idle state.

In some embodiments, after obtaining the first system information carrying the LP WUS configuration information, the user equipment 101 may switch to a state of monitoring the LP WUS, and monitor the LP WUS through a low-power receiver at a corresponding time-frequency location in accordance with the time-frequency resource configured in the LP WUS configuration information. In the state of monitoring the LP WUS, the main receiver may be in a sleep state to achieve energy saving of the user equipment 101.

In the embodiments of the present disclosure, before monitoring the first system information, the user equipment 101 needs to first transmit the SI request to the network device 102, and then monitor the corresponding first system information transmitted by the network device 102 based on the SI request.

An embodiment of the present disclosure provides a method for monitoring system information, and the method is performed by a user equipment. FIG. 5 is a flowchart illustrating a method for monitoring system information according to an embodiment of the present disclosure. As shown in FIG. 5, the method includes the following step S501.

At step S501, when the first condition is met, the user equipment 101 monitors the first system information transmitted by the network device 102, where the first system information includes LP WUS configuration information.

In some embodiments, the LP WUS configuration information includes one or more of: a time domain resource, a frequency domain resource, power information, spatial information and the like for transmitting the LP WUS. The spatial information can be configured to indicate transmitting and receiving beam information.

In some embodiments, the first condition includes that: the upper layer of the user equipment 101 has a request to monitor the LP WUS. The upper layer can be an application layer, and the application layer may transmit a request to monitor the LP WUS to the physical layer for energy saving. The physical layer, after receiving a request from the upper layer to monitor the LP WUS, needs to monitor the first system information carrying the LP WUS configuration information before monitoring the LP WUS to obtain valid LP WUS configuration information.

In some embodiments, the first condition includes that: the upper layer of the user equipment 101 determines that the channel quality measurement result is greater than or equal to the corresponding threshold value. When the channel quality measurement result is better, the monitoring quality of the LP WUS is considered to be better as well, and the user equipment 101 can switch to the state of monitoring the LP WUS to achieve energy saving. Before switching to the state of monitoring the LP WUS, the user equipment 101 needs to monitor the first system information carrying the LP WUS configuration information to obtain the valid LP WUS configuration information.

The user equipment 101 is a user equipment in the RRC idle state.

In some embodiments, after obtaining the first system information carrying the LP WUS configuration information, the user equipment 101 may switch to an energy-saving state of monitoring the LP WUS, and monitor the LP WUS through a low-power receiver at a corresponding time-frequency location in accordance with the time-frequency resource configured in the LP WUS configuration information. In the state of monitoring the LP WUS, the main receiver may be in a sleep state to achieve energy saving of the user equipment 101.

In the embodiments of the present disclosure, the user equipment 101 monitors the first system information, carrying the LP WUS configuration information, transmitted by the network device 102 when a certain condition is met, and obtains the first system information in time so as to accurately monitor the LP WUS according to the valid LP WUS configuration information in the energy-saving state, such that the energy-saving effect is to ensured.

An embodiment of the present disclosure provides a method for monitoring system information, and the method is performed by a user equipment. The method includes the following step S501′.

At step S501′, when the first condition is met, the user equipment 101 monitors the first system information broadcast by the network device 102, where the first system information includes LP WUS configuration information.

In some embodiments, the network device 102 may broadcast the first system information carrying the LP WUS configuration information according to a preset period.

In some embodiments, the first condition includes that: the upper layer of the user equipment 101 has a request to monitor the LP WUS. For example, the physical layer of the user equipment 101 receives a request from a upper layer to monitor the LP WUS.

In some embodiments, the first condition includes that: the channel quality measurement result of the user equipment 101 is greater than or equal to the corresponding parameter threshold value.

In the embodiments of the present disclosure, the user equipment 101 does not need to transmit system information (SI) request information, the network device 102 actively broadcasts the first system information, and the user equipment 101 monitors the first system information when the first condition is met.

An embodiment of the present disclosure provides a method for monitoring system information, and the method is performed by a user equipment. FIG. 6 is a flowchart illustrating a method for monitoring system information according to an embodiment of the present disclosure. As shown in FIG. 6, the method includes the following steps S601 to S602.

At step S601, when the first condition is met, the user equipment 101 transmits a system information (SI) request to the network device 102, where the SI request is configured to request the first system information including the LP WUS configuration information.

At step S602, the user equipment 101 monitors the first system information transmitted by the network device 102.

In some embodiments, the first condition includes that: the upper layer of the user equipment 101 has a request to monitor the LP WUS.

In some embodiments, the first condition includes that: the channel quality measurement result of the user equipment 101 is greater than or equal to the corresponding parameter threshold value.

In the embodiments of the present disclosure, before monitoring the first system information, the user equipment 101 needs to first transmit the SI request to the network device 102, and then monitor the corresponding first system information transmitted by the network device 102 based on the SI request.

An embodiment of the present disclosure provides a method for monitoring system information, and the method is performed by a user equipment. The method includes the steps S601 to S602, the first condition includes that: the channel quality measurement result of the user equipment 101 is greater than or equal to the corresponding parameter threshold value.

The channel quality measurement result is a measurement result corresponding to a reference signal of a serving cell.

In some embodiments, the user equipment 101 measures a reference signal (RS) of a serving cell to obtain a channel quality measurement result.

In some embodiments, the channel quality measurement result may be represented by reference signal receiving power (RSRP).

In some embodiments, the reference signal is a synchronization signal and physical broadcast channel (PBCH) block (SSB).

In some embodiments, the reference signal is a channel state information-reference signal (CSI-RS).

In some embodiments, the parameter threshold value is defined by a protocol or configured by the network device.

In an example, the value corresponding to the parameter threshold value or the way in which the parameter threshold value is determined is defined by the protocol. For example, the parameter threshold value is related to at least one of: a difference between a transmit power of the reference signal and a transmit power of the LP WUS; or a sensitivity of a receiver for receiving the LP WUS.

In another example, the network device 102 may configure the value corresponding to the parameter threshold value for the user equipment 101. Alternatively, the network device 102, after determining the parameter threshold value according to the protocol, transmits indication information carrying the parameter threshold value to the user equipment 101.

In some embodiments, the parameter threshold value is related to at least one of: a difference between a transmit power of the reference signal and a transmit power of the LP WUS; or a sensitivity of a receiver for receiving the LP WUS.

In this embodiment, the sensitivity of the low-power receiver of the user equipment 101 receiving the LP WUS, as well as the sensitivity of the main receiver can be obtained and recorded during factory testing of the terminal.

In this embodiment, the sensitivity of the low-power receiver is generally lower than that of the main receiver. Therefore, the coverage performance of the wake up signal for the low-power receiver is poor under the same power condition.

In this embodiment, when the channel quality measurement result is better, the monitoring quality of the LP WUS is considered to be better as well, and the user equipment 101 can switch to the state of monitoring the LP WUS to achieve energy saving.

For the convenience of understanding this embodiment, the following is a specific example.

For example, the sensitivity of the low-power receiver of the user equipment 101 is −80 dbm, which can express the minimum received power of the low-power receiver.

The user equipment 101 in the RRC idle state activates the main receiver to receive the SSB or the paging information.

When the user equipment 101 measures that the value of the reference signal receiving power (RSRP) of the SSB is −100 dbm. The user equipment 101 also receives that the LP WUS broadcast by the network device 102 has a power offset (difference in transmit power) of +12 dbm compared to the SSB, i.e., the transmit power of the LP WUS is 12 dbm higher than the transmit power of the SSB. If the number of repetitions for the LP WUS is 4, it is equivalent to a repetition gain of 6 dB.

According to the protocol, the user equipment 101 estimates the received power of the LP WUS to be −100+12+6=−82 dbm, which has not yet reached the sensitivity of −80 dbm corresponding to the low-power receiver. Therefore, the user equipment 101 can determine that the low-power receiver does not yet need to be activated.

When the user equipment 101 measures the value of the RSRP of the SSB at −95 dbm, the difference between the transmit power of the SSB and the transmit power of the LP WUS is still +12 dbm, and the repetition gain is still 6 dB.

According to the protocol, the user equipment 101 estimates the received power of the LP WUS to be −95+12+6=−77 dbm, which has reached the sensitivity of −80 dbm corresponding to the low-power receiver. Therefore, the user equipment 101 can activate the low-power receiver.

Based on the same conception as the method embodiments, embodiments of the present disclosure further provide an apparatus for monitoring system information that may have the functions of the user equipment 101 in the method embodiments and be used to perform the steps provided in the method embodiments and performed by the user equipment 101. The functions may be implemented by software, or by hardware executing corresponding software. The hardware or software includes one or more modules corresponding to the above-mentioned functions.

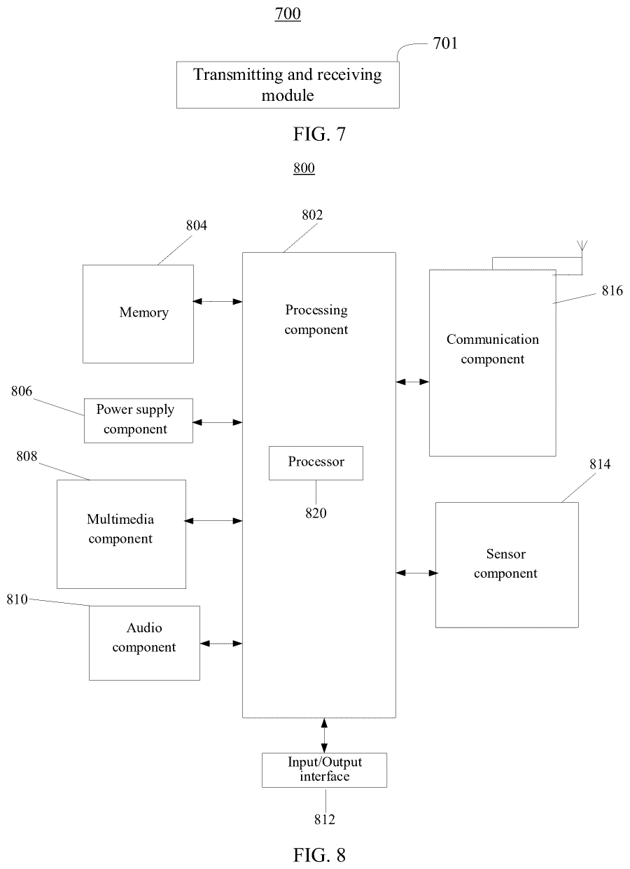

In an embodiment, an apparatus 700 as shown in FIG. 7 may serve as the user equipment 101 involved in the method embodiments and perform the steps performed by the user equipment 101 in the method embodiments. As shown in FIG. 7, the apparatus 700 may include a transmitting and receiving module 701, where the transmitting and receiving module 701 may be configured to support communication between communication devices, and the transmitting and receiving module 701 may have a wireless communication function, for example, wireless communication with other communication devices through a new radio air interface.

In performing the steps performed by the network device 101, the transmitting and receiving module 701 is configured to: in response to a first condition being met, monitor first system information transmitted by a network device, where the first system information includes low power wake up signal (LP WUS) configuration information.

When the apparatus for monitoring system information is a user equipment 101, its structure may also be shown in FIG. 8. The device 800 can be a mobile phone, a computer, a digital broadcast terminal, a message transmitting and receiving device, a gaming console, a tablet device, a medical device, a fitness device, a personal digital assistant, and the like.

Referring to FIG. 8, device 800 can include one or more of the following components: processing component 802, memory 804, power component 806, multimedia component 808, audio component 810, input/output (I/O) interface 812, sensor component 814, and a communication component 816.

The processing component 802 usually controls overall operations of the device 800, such as operations related to display, a telephone call, data communication, a camera operation and a record operation. The processing component 802 may include one or more processors 820 to execute instructions to complete all or a part of the steps of the above methods. In addition, the processing component 802 may include one or more modules which facilitate the interaction between the processing component 802 and other components. For example, the processing component 802 may include a multimedia module to facilitate the interaction between the multimedia component 808 and the processing component 802.

The memory 804 is configured to store different types of data to support operations at the device 800. Examples of such data include instructions, contact data, phone book data, messages, pictures, videos, and so on for any application or method that operates on the device 800. The memory 804 may be implemented by any type of volatile or non-volatile storage devices or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The power supply component 806 provides power for different components of the device 800. The power supply component 806 may include a power management system, one or more power sources, and other components associated with generating, managing and distributing power for the device 800.

The multimedia component 808 includes a screen for providing an output interface between the device 800 and a user. In some embodiments, the screen may include a liquid crystal display (LCD) and/or a touch panel (TP). If the screen includes a touch panel, the screen may be implemented as a touch screen for receiving an input signal from a user. The touch panel may include one or more touch sensors for sensing a touch, a slide and a gesture on the touch panel. The touch sensor may not only sense a boundary of a touching or sliding movement, but also detect duration and pressure related to the touching or sliding operation. In some examples, the multimedia component 808 may include a front camera and/or a rear camera. When the device 800 is in an operation mode, such as a shooting mode or a video mode, the front camera and/or the rear camera may receive external multimedia data. Each of the front camera and the rear camera may be a fixed optical lens system or be of a focal length and a capability of an optical zoom.

The audio component 810 is configured to output and/or input an audio signal. For example, the audio component 810 may include a microphone (MIC). When the device 800 is in an operating mode, such as a call mode, a recording mode and a speech recognition mode, the microphone is configured to receive an external audio signal. The received audio signal may be further stored in the memory 804 or sent via the communication component 816. In some examples, the audio component 810 also includes a speaker for outputting an audio signal.

The I/O interface 812 may provide an interface between the processing component 802 and peripheral interface modules. The above peripheral interface modules may include a keyboard, a click wheel, buttons and so on. Such buttons may include but not limited to: a home button, a volume button, a start button and a lock button.

The sensor component 814 includes one or more sensors for providing state assessments in different aspects for the device 800. For example, the sensor component 814 may detect an on/off state of the device 800 and a relative location of components. For example, the components are a display and a keypad of the device 800. The sensor component 814 may also detect a position change of the device 800 or a component of the device 800, presence or absence of a touch of a user on the device 800, an orientation or acceleration/deceleration of the device 800, and a temperature change of the device 800. The sensor component 814 may include a proximity sensor for detecting the existence of a nearby object without any physical touch. The sensor component 814 may also include a Complementary Metal-Oxide-Semiconductor (CMOS) or Charged Coupled Device (CCD) image sensor applied in an imaging application. In some examples, the sensor component 814 may also include an acceleration sensor, a gyro sensor, a magnetic sensor, a pressure sensor, or a temperature sensor.

The communication component 816 is configured to facilitate wired or wireless communication between the device 800 and other devices. The device 800 may access a wireless network based on a communication standard, such as Wi-Fi, 2G or 3G, or a combination thereof. In examples, the communication component 816 receives a broadcast signal or broadcast related information from an external broadcast management system via a broadcast channel. In examples, the communication component 816 may also include a Near Field Communication (NFC) module to facilitate short-range communications. For example, the NFC module may be implemented based on a radio frequency identification (RFID) technology, an infrared data association (IrDA) technology, an ultra wide band (UWB) technology, a Bluetooth (BT) technology and other technologies.

In an example, the device 800 may be implemented by one or more application specific integrated circuits (ASIC), digital signal processors (DSP), digital signal processing devices (DSPD), programmable logic devices (PLD), field programmable gate arrays (FPGA), controllers, microcontrollers, microprocessors or other electronic elements, for executing the method in any one of the above examples.

In an example, a non-transitory computer readable storage medium including instructions, such as the memory 804 including instructions, is also provided. The above instructions may be executed by the processor 820 of the device 800 to complete the method. For example, the non-transitory computer readable storage medium may be a read-only memory (ROM), a random access memory (RAM), a CD-ROM, a magnetic tape, a floppy disk and an optical data storage device, etc.

After considering the specification and practicing the present disclosure, those skilled in the art would easily conceive of other implementations of the present disclosure. The present disclosure is intended to include any variations, uses and adaptive changes of the present disclosure. These variations, uses and adaptive changes follow the general principle of the present disclosure and include common knowledge or conventional technical means in the prior art not disclosed in the present disclosure. The specification and examples are considered as exemplary only, with a true scope and spirit of the present disclosure being indicated by the following claims.

Based on the same conception as the method embodiments, embodiments of the present disclosure further provide an apparatus for transmitting system information that may have the functions of the network device 102 in the method embodiments and be used to perform the steps provided in the method embodiments and performed by the network device 102. The functions may be implemented by software, or by hardware executing corresponding software. The hardware or software includes one or more modules corresponding to the above-mentioned functions.

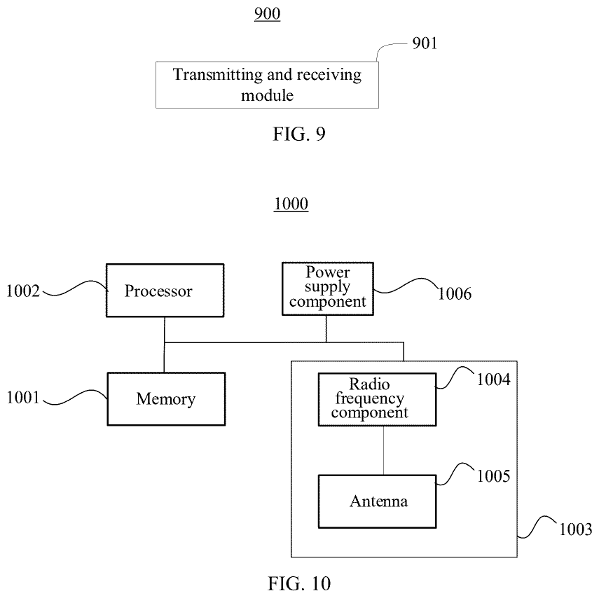

In an embodiment, an apparatus 900 as shown in FIG. 9 may serve as the network device 102 involved in the method embodiments and perform the steps performed by the network device 102 in the method embodiments. As shown in FIG. 9, the apparatus 900 may include a transmitting and receiving module 901, where the transmitting and receiving module 901 may be configured to support communication between communication devices, and the transmitting and receiving module 901 may have a wireless communication function, for example, wireless communication with other communication devices through a new radio air interface.

When performing the steps implemented by the network device 102, the transmitting and receiving module 901 is configured to transmit the system information.

When a communication device is a network device 102, its structure may also be shown in FIG. 10. The structure of the communication device is illustrated by the example of the base station. As shown in FIG. 10, the communication device 1000 includes a memory 1001, a processor 1002, a transmitting and receiving component 1003, and a power supply component 1006. The memory 1001 is coupled to the processor 1002 and may be configured to store programs and data necessary for the communication device 1000 to implement various functions. The processor 1002 is configured to support the communication device 1000 to perform the corresponding function in the above-mentioned methods, which can be realized by calling the programs stored in the memory 1001. The transmitting and receiving component 1003 may be a wireless transceiver that may be used to support the communication device 1000 to receive signaling and/or data through a radio Interface, as well as to transmit signaling and/or data. The transmitting and receiving component 1003 may also be referred to as a transmitting and receiving unit or a communication unit, and the transmitting and receiving component 1003 may include an radio frequency (RF) component 1004 and one or more antennas 1005, where the RF component 1004 may be a remote radio unit (RRU), which may be specifically used for transmission of RF signals and conversion of RF signals to baseband signals, and the one or more antennas 1005 may be specifically used to perform radiation and reception of RF signals.

When the communication device 1000 needs to transmit data, the processor 1002 can perform baseband processing on the data to be transmitted, and then output a baseband signal to the radio frequency unit, and the radio frequency unit performs radio frequency processing on the baseband signal and then transmits the radio frequency signal in the form of electromagnetic waves through the antenna. When there is data transmitted to the communication device 1000, the radio frequency unit receives the radio frequency signal through the antenna, converts the radio frequency signal to a baseband signal, and outputs the baseband signal to the processor 1002, and the processor 1002 converts the baseband signal to data and processes the data.

It is to be understood that the present disclosure is not limited to the precise construction described herein and shown in the drawings, and that various modifications and changes may be made without departing from the scope thereof. The scope of the present disclosure is to be limited only by the appended claims.

### INDUSTRIAL UTILITY

In the method of the present disclosure, the user equipment monitors the first system information carrying the LP WUS configuration information transmitted by the network device when a certain condition is met, and obtains the first system information in time so as to accurately monitor the LP WUS according to the valid LP WUS configuration information in the energy-saving state, such that the energy-saving effect is to ensured.

1. A method for monitoring system information, performed by a user equipment, comprising:
in response to a first condition being met, monitoring first system information transmitted by a network device, wherein the first system information comprises low power wake up signal (LP WUS) configuration information.

2. The method of claim 1, wherein monitoring the first system information transmitted by the network device comprises:
monitoring the first system information broadcast by the network device.

3. The method of claim 1, wherein monitoring the first system information transmitted by the network device comprises:
transmitting a system information (SI) request to the network device, wherein the SI request is configured to request the first system information comprising the LP WUS configuration information; and
monitoring the first system information transmitted by the network device.

4. The method of claim 1, wherein the first condition comprises that:
an upper layer of the user equipment has a request to monitor a LP WUS.

5. The method of claim 1, wherein the first condition comprises that:
a channel quality measurement result of the user equipment is greater than or equal to a parameter threshold value.

6. The method of claim 5, wherein the channel quality measurement result is a measurement result corresponding to a reference signal of a serving cell.

7. The method of claim 6, wherein the reference signal is a synchronization signal and physical broadcast channel (PBCH) block (SSB).

8. The method of claim 5, wherein the parameter threshold value is defined by a protocol or configured by the network device.

9. The method of claim 8, wherein the parameter threshold value is related to at least one of:
a difference between a transmit power of the reference signal and a transmit power of the LP WUS; or
a sensitivity of a receiver for receiving the LP WUS.

10. (canceled)

11. A user equipment, comprising:
a processor; and
a memory, wherein
the memory is configured to store computer programs executable by the processor; and
the processor is configured to:
in response to a first condition being met, monitor first system information transmitted by a network device, wherein the first system information comprises low power wake up signal (LP WUS) configuration information.

12. A non-transitory computer-readable storage medium, storing instructions thereon, wherein the instructions, when executed by a processor, cause the processor to perform:
in response to a first condition being met, monitoring first system information transmitted by a network device, wherein the first system information comprises low power wake up signal (LP WUS) configuration information.

13. The user equipment of claim 11, wherein the processor is further configured to:
monitor the first system information broadcast by the network device.

14. The user equipment of claim 11, wherein the processor is further configured to:
transmit a system information (SI) request to the network device, wherein the SI request is configured to request the first system information comprising the LP WUS configuration information; and
monitor the first system information transmitted by the network device.

15. The user equipment of claim 11, wherein the first condition comprises that:
an upper layer of the user equipment has a request to monitor a LP WUS.

16. The user equipment of claim 11, wherein the first condition comprises that:
a channel quality measurement result of the user equipment is greater than or equal to a parameter threshold value.

17. The user equipment of claim 16, wherein the channel quality measurement result is a measurement result corresponding to a reference signal of a serving cell.

18. The user equipment of claim 17, wherein the reference signal is a synchronization signal and physical broadcast channel (PBCH) block (SSB).

19. The user equipment of claim 16, wherein the parameter threshold value is defined by a protocol or configured by the network device.

20. The user equipment of claim 19, wherein the parameter threshold value is related to at least one of:
a difference between a transmit power of the reference signal and a transmit power of the LP WUS; or
a sensitivity of a receiver for receiving the LP WUS.
